(19) United States
(12) Patent Application Publication
(10) Pub. No.: US 2006/0143921 A1
(43) Pub. Date: Jul. 6, 2006

(54) Modular construction coach body for large vehicles, in particular rail vehicles for passenger transport and method for production of such a coach body

(76) Inventors: Klaus Altenburg, Wurselen (DE); Walter Aretz, Raeren (BE); Andreas Huepperling, Kempen (DE); Gerd Meyer, Leverkusen (DE); Gerhard Nolting, Bochum (DE); Stefan Wanczura, Recklinghausen (DE)

Correspondence Address: HARNESS, DICKEY & PIERCE, P.L.C., P.O.BOX 8910, RESTON, VA, 20195, US

(21) Appl. No.: 10/540,252

(22) PCT Filed: Dec. 12, 2003
(86) PCT No.: PCT/DE03/04120

§ 371 Date: Jan. 31, 2006

(30) Foreign Application Priority Data
Dec. 23, 2002 (DE) 102 60 768.0

(51) Int. Cl. B21D 53/88; B60J 9/00

(52) U.S. Cl. 29/897.2; 29/469; 296/1.01

(57) ABSTRACT

The modules for the coach body are divided into module sections and individual pre-assembled sub-assemblies, whereby the modules are produced by joining the individual pre-assembled sub-assemblies to provide module sections and by subsequent joining of the module sections. The joining of the individual pre-assembled sub-assemblies to provide module sections or modules, the joining of the module sections to provide modules and the joining of modules to provide the complete coach body is carried out by cold joining with rapid connector elements (e.g. cold mountable connection elements) and/or specially produced connector components.

This application is a PCT National Stage Application of PCT/DE2003/004120 filed Dec. 12, 2003, which claims priority under on German Patent Application No. DE 102 60 768.0 filed in Germany on Dec. 23, 2002, the entire contents of which is hereby incorporated herein by reference.

### FIELD

The invention generally relates to a modularly constructed coach body for spacious vehicles, in particular rail vehicles for passenger transport, and/or to a method for producing such a coach body.

### BACKGROUND

Local content contracts, as they are referred to, are concluded with increasing frequency between the manufacturers of rail vehicles and their customers. In such contracts, the manufacturers undertake, when manufacturing their vehicles, to implement a defined part of the overall net production in the customers' respective country. As such, the assembly of the vehicles is carried out at least partially in the customers' country.

This trend will be accentuated in future, even the manufacturer of coach body carcasses increasingly being shifted in future to customer countries by virtue of local content contracts. This presents the problem that fully equipped manufacturing locations have to be used in the customers' country. Furthermore, the employment of qualified personnel on the spot is a necessary condition for the assembly of coach bodies where a foreign customer is concerned.

### SUMMARY

One object of an embodiment of the present invention is to make it possible to fulfill local content contracts, particularly in rail vehicle construction, with a lesser or even the least possible requirements in terms of equipment and personnel for the manufacturing location.

The modular principle of manufacture is gaining increasing acceptance in the rail vehicle industry. In this context, a vehicle is subdivided into defined individual subassemblies (modules). The manufacturers keep various variants for each module. It is thereby possible to react flexibly to different customer wishes.

This modular principle reaches its limit when customer wishes cannot be satisfied by available variants. An embodiment of the present invention is intended to abolish the principle of structurally fixed variants of individual modules. Instead, the variables of a module are to be assigned a bandwidth, within which they can be varied freely, so that the products attain a maximum degree of individualization.

The interaction of local content and modularization involves a further problem of transporting modules which are finally assembled in the customers' country. The modules often cannot be packaged in containers because the dimensions are too large. An embodiment of the present invention is aimed at combining the concept of modularization with the demand for container compatibility of the components.

As already mentioned, in order to fulfill local content contracts, the manufacturers of rail vehicles usually resort to the manufacturing installations existing in the customer's country. In this case, there is often the need to upgrade technical equipment and the qualification of the labor force at the relevant location. This leads to an increase in costs and causes a usually undesirable export of know-how.

This is explained in more detail by the example of rail vehicles with coach bodies in an integral aluminum type of construction: the partial manufacture of corresponding carcasses abroad necessitates the export of expert competence in specialized areas, such as welding technology and fixture of a construction. After the completion of the carcass, personnel often likewise have to be trained for subsequent work steps, for example for adhesive bonding during interior finishing and in the region of the windows.

The state of the art in the modular manufacture of rail vehicles is to subdivide the coach body into large modules, such as the roof, side walls, end walls and undercarriage. However, in particular, complete side walls, roofs and undercarriages are not container-compatible because of their dimensions. It is not possible at the present time for the modules to be broken down to smaller and therefore container-compatible subassemblies. The current modular manufacturing concepts therefore cannot satisfy the requirements of the local content contract. Instead, coach bodies of rail vehicles are nowadays manufactured, complete, either at the manufacturer's or at the customer's.

Since, in the current situation of modularly constructed rail vehicles, individual customer wishes cannot be satisfied, new variants have to be added to existing module families. This usually necessitates complete redevelopments of individual modules. This results in an increase in costs, on the one hand due to additional engineering and, on the other hand, due to an increase in the outlay in logistical terms on account of additional individual parts.

An object of an embodiment of the invention includes designing a coach body in as simple and as cost-effective a way as possible, so that the aims and requirements described above are fulfilled. The coach body to be produced is therefore to be capable, in particular without complete redevelopments, of being adapted to individual customer wishes and is to be capable of being produced even in the case of a relatively low degree of technical equipment and qualification of the personnel at the manufacturing location, transportability in conventional containers having to be taken into consideration.

An embodiment of the present invention relates to a coach body modularly constructed by the quick assembly technique in a differential geometrically variable type of construction for vehicles intended particularly for railborne passenger transport.

Individually prefabricated subassemblies are used for assembling the coach body. The term “quick assembly technique” here includes both the cold joining of these subassemblies into module sections and the cold joining of the module sections into complete modules and, ultimately, into the overall structure of the coach body by way of quick connection elements and specially-designed connection subassemblies. The quick connection elements used may include, in particular, insertion elements, such as rivets, retaining ring bolts and blind rivet nuts. Thermal joining methods are eliminated in the quick assembly technique. Type-specific fixtures are not required either for joining or for shaping.

In the type of construction described here, the term “module sections” includes, for example, individual window panels, from which a complete side wall module is subsequently joined together. Thus, in an embodiment of the present invention, the modular principle is subdivided into three separate levels: individually prefabricated subassemblies, module sections and modules. By individually prefabricated subassemblies being joined together, module sections are obtained, and by module sections being joined together, modules are obtained. Smaller modules, such as end walls, do not necessarily have to be subdivided into module sections, but can be joined together directly from individually prefabricated subassemblies.

The entire process involving the quick assembly of the coach body can be carried out on the spot where a foreign customer is concerned, without a fully equipped manufacturing location for rail vehicles being required there. The need for training the fitters at such a location is also greatly reduced, in particular due to the elimination of training courses in welding and to the abolition of type-specific fixture construction. The export of know-how is minimized because of the simplicity of the assembly steps carried out at the customer's.

The individually prefabricated subassemblies, the module sections joined together by the quick assembly technique and the small modules joined together directly from prefabricated subassemblies have a maximum dimensioning such that packaging in containers is possible. The technically demanding manufacturing of subassemblies and optionally also the production of module sections, such as window panels, or the production of small modules, such as end walls, can therefore take place at the manufacturer's. The subsequent steps of assembling the coach body can be carried out on the spot at the customer's. Owing to the container compatibility of the individually prefabricated subassemblies and also of the module sections and of the small modules produced directly from prefabricated subassemblies, an embodiment of the present invention combines the concept of modularization with the demand of the local content contract, while keeping the essential know-how at the manufacturer's.

All the quick connection elements and specially-designed connection subassemblies used form releasable connections. In the event of damage, therefore, severance cutting methods and thermal severance methods can be dispensed with when subassemblies are being demounted. When prefabricated replacement subassemblies are being mounted, the interfaces required for cold joining are available to the full extent, so that thermal joining methods may likewise be dispensed with.

The basis of the quick assembly technique described is the sufficiently accurate production of the prefabricated subassemblies. This is achieved by designing the subassemblies by way of three-dimensional parametric computer-aided design technology (CAD) and by transferring the CAD model data thus generated to computer-assisted manufacturing processes, such as laser cutting, laser welding or CNC open-die bending.

In an embodiment of the present invention, the principle of structurally fixed variants of individual modules is abolished. Instead, the variables of modules and module sections are assigned a bandwidth, within which they can be varied freely. The basis of this novel principle of manufacture is the assembly of modules and module sections from individually prefabricated subassemblies. In this case, a distinction is made between invariable subassemblies and variable subassemblies. The specially-designed connection subassemblies are an example of invariable subassemblies. A variable subassembly includes, for example, the vertically running mechanically load-bearing profile, conventionally designed as a rectangular tube, of a window panel with tied-on individual parts of specially-designed connection subassemblies.

For this profile, there are no variants developed with a different, but in each case a fixed radius of curvature, but, instead, with the aid of the computer-assisted manufacturing method described above, all conceivable radii can be implemented, within a defined bandwidth, without additional engineering and without an increased outlay in logistic terms. The modules can thus be varied freely within a defined bandwidth by means of the variable subassemblies. The products thereby achieve the highest possible degree of individualization.

In an embodiment of the present invention, a differential type of construction is employed. The basis of this type of construction is the fundamental division of each module section and of each module joined together directly from prefabricated subassemblies into a statically load-bearing lightweight skeleton, joined together from individual prefabricated subassemblies by way of the quick assembly technique, and an outer and an inner cladding which are mounted onto the skeleton likewise by the quick assembly technique.

The lightweight skeleton preferably consists of metal or of fiber-reinforced plastic. The quick connection elements and the specially-designed connection subassemblies of the cold-joined lightweight skeleton form a gridwork of connection points for connecting the inner and the outer claddings. Thus, during the assembly of the skeleton, for example, blind rivet nuts are used, which, in turn, have threads for connecting the claddings. The attachment of additional connection elements by means of thermal methods is dispensed with.

As described above, the specially-designed connection subassemblies belong to the invariable subassemblies. The connection subassemblies are standardized, that is to say there is a fixed assortment, by means of which any function and any mechanical stressing of joining points within the vehicle structure can be fulfilled. The individual parts of the connection subassemblies are preferably metallic castings or metal parts machined by cutting, which are tied to individually prefabricated skeleton subassemblies, in particular by means of the low-distortion laser welding technique. The individual parts and therefore also the tied-on subassemblies are joined together by the quick assembly technique.

In an intermediate stage of rapid assembly, the modules or module sections are equipped with the associated installation components. These are, for example, the windows and also public address, lighting, ventilation, air conditioning and indicator instruments. Furthermore, the modules or module sections are equipped with the required electrical, pneumatic, hydraulic or optical lines and with the corresponding connection elements for coupling the lines during the further assembly process. The individual modules or module sections are preassembled to an extent such that they can be pretested fully for functioning and quality before being joined together.

Owing to the free accessibility of the modules or module sections during the tests and on account of the low outlay in demounting and mounting terms in the event of fault rectification, the transit time during vehicle production is reduced or even minimized. When the finished vehicle is commissioned, a further time saving is achieved in that faults are to be sought only in the region of the joining points of the modules or module sections.

Each module and each module section can be brought into the position which is the most favorable for manufacture. Accessibility and ergonomics during manufacture are thereby optimized. Furthermore, the assembly of a module or module section is independent of the state of assembly of other modules and module sections. As a result of the quick assembly technique, the favorable positioning and the independent execution of parallel assembly steps on the individual modules and module sections, the transit time during vehicle production is further reduced. There is therefore less capital tied up, as compared with conventional production methods.

### BRIEF DESCRIPTION OF THE DRAWINGS

Further, the invention is described in more detail with reference to an example embodiment illustrated in principle in the drawings in which:

FIG. 1 shows part of a coach body in perspective view,

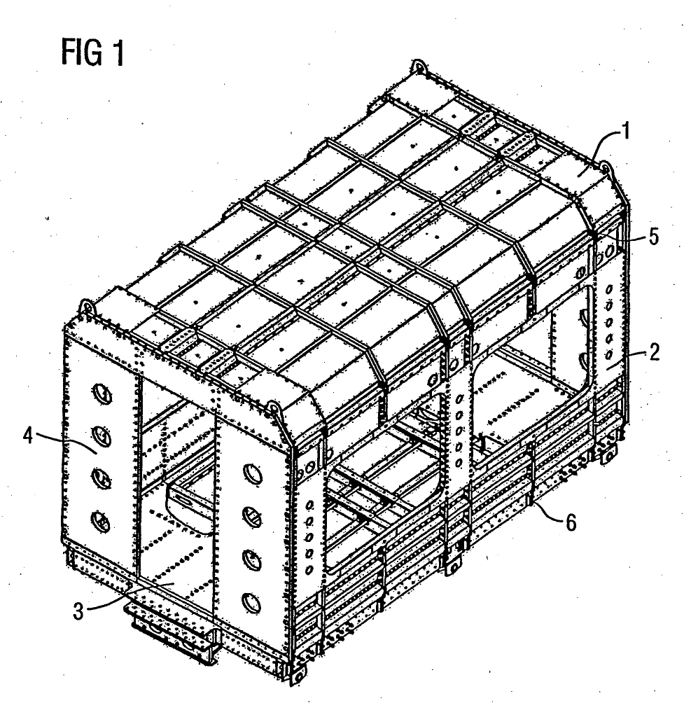

FIG. 2 shows the coach body according to FIG. 1 in an exploded illustration,

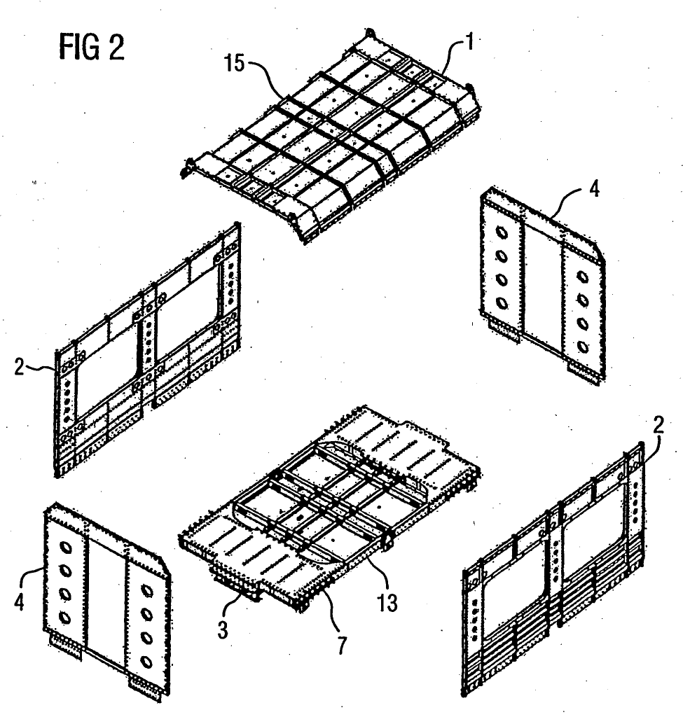

FIG. 3 shows a window panel as a module section of a side wall module in a perspective view enlarged in relation to FIGS. 1 and 2,

FIG. 4 shows profile subassemblies and sheet metal subassemblies of the window panel according to FIG. 3 in an exploded illustration.

### DETAILED DESCRIPTION OF THE EXAMPLE EMBODIMENTS

In an example embodiment of the present invention, the statically load-bearing lightweight skeleton consists of individually prefabricated profile subassemblies 8 and of individually prefabricated sheet metal subassemblies 9. Both the profile assemblies 8 and the sheet metal subassemblies 9 all have blanks, bores and shapings required for joining compatible with quick assembly and also have tied-on individual parts of specially-designed connection subassemblies. The profiles and sheets are manufactured from austenitic high-grade steel. The blanks and bores are produced by means of a CNC-controlled laser cutting plant.

The profiles are shaped by way of CNC-controlled open-die bending machines. The respective CNC data are generated, computer-assisted, from the three-dimensional CAD model data. The individual parts of the specially-designed connection subassemblies are preferably precision castings consisting of stainless duplex steel or are produced from high-grade steel blanks by means of cutting machining. The individual parts are tied up to the profiles by means of low-distortion laser welding.

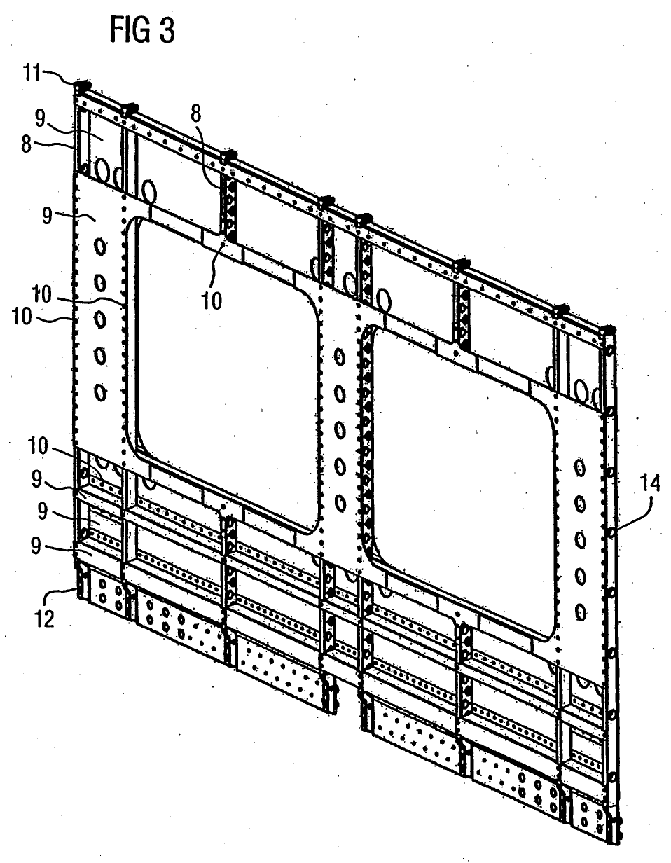

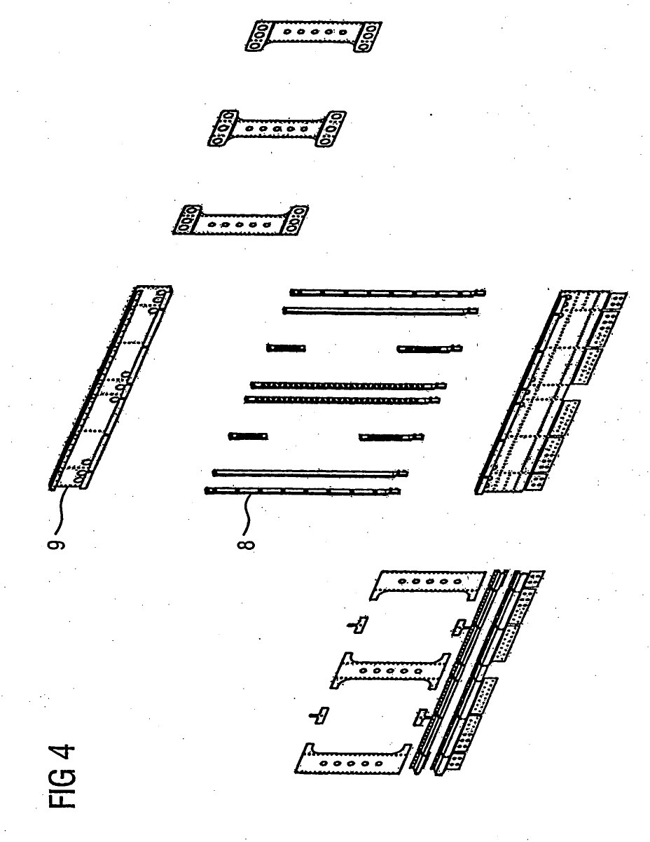

One example of an individually prefabricated profile subassembly (see FIGS. 3 and 4) is a profile 8 designed as a rectangular tube and having individual parts, tied up on the end faces, of connection subassemblies 11 and 12, the profile running vertically in the module sections of a side wall module which are designated as window panels 2. This subassembly is produced in four steps. First, the profile is cut to length in a CNC-controlled laser cutting plant. After blank cutting, the bores are introduced in the same plant. Subsequently, the blank-cut and drilled profile is bent according to the desired side wall radius in a CNC-controlled open-die bending machine. Lastly, the individual parts of connection subassemblies 11 and 12 are tied up to the two end faces of the profile by means of laser welds.

One example of an individually prefabricated sheet metal subassembly 9 is a slide sheet of a window panel 2. Here, too, blank cutting and drilling are carried out on a CNC-controlled laser cutting plant. Since the CNC data are generated, computer-assisted, from the three-dimensional CAD model data, the subsequent edging and bending process is already taken into account in the placement of the blank cuts and bores.

The load-bearing lightweight skeletons of module sections and modules are produced by the quick assembly technique from the individually prefabricated profile subassemblies 8 and the individually prefabricated sheet metal subassemblies 9 by way of blind rivet nuts 10, retaining ring bolts 7, rivets and punched rivets and also specially-designed connection subassemblies 5 and 6. Here, too, the window panel of a side wall module 2 is intended to serve as an example.

The individually prefabricated sheet metal subassemblies 9 are tied up to the individually prefabricated profile subassemblies 8 by use of blind rivet nuts 10. In this case, only the bores introduced into the sheets and profiles during the prefabrication of the sheet and profile subassemblies are used. The window panel 2 thereby acquires its final geometry automatically without a type-specific fixture. Adjacent sheets are connected along mutual overlaps by use of punched rivets.

The lightweight skeletons of the module sections of the roof module 1, the lightweight skeletons of the end wall modules 4 and the lightweight skeletons of the door modules and head module are produced correspondingly. The prefabricated side member profile subassemblies 13 are additionally tied up to the module sections of the undercarriage module 3 by use of retaining ring bolt connections 7.

According to an embodiment of the invention, before being joined together, the module sections and modules are fully equipped with the inner and the outer cladding and with the associated installation components, such as windows, public address, lighting, ventilation, air conditioning and indicator instruments. Moreover, the electrical, hydraulic, pneumatic and optical lines and the corresponding connection elements for coupling the lines during the further assembly process are attached.

The inner and the outer cladding are mounted by the cold joining technique by way of screws or rivets. In this case, the quick connection elements and the specially-designed connection subassemblies of the statically load-bearing lightweight skeletons form gridworks of connection points for connecting the claddings. This, too, will be explained in more detail by the example of a window panel 2.

The blind rivet nuts 10 used for joining together individually prefabricated sheet metal subassemblies 9 and profile subassemblies 8 of the statically load-bearing lightweight skeleton have threads at which the cladding elements are tied up. The electrical, pneumatic, hydraulic and optical lines are preferably attached between the lightweight skeleton and the inner cladding. The fastening both of the lines and of the installation components may take place on the lightweight skeleton and/or on the inner cladding.

The fully equipped module sections are joined together by the quick assembly technique to form the module. This will be explained again by the example of window panels 2 which are joined together to form the side wall module. During the prefabrication of the profile subassemblies, bush-shaped individual parts of specially-designed connection subassemblies 14 were introduced by use of laser welds into the profiles running vertically and flush with the outer edge of a window panel.

Two window panels 2 lying next to one another are joined together as a result of the connection of these individual parts by way of the quick assembly technique. A specially designed screw connection, which completes the corresponding connection subassembly, is used here for quick assembly. The electrical, hydraulic, pneumatic and optical lines are coupled by the associated connection elements being joined together. After the connection of all the window panels, the complete side wall module is finished. The module sections of the roof module and undercarriage module are joined together correspondingly to form the corresponding overall modules.

The fully equipped modules are joined together by the quick assembly technique to form the overall structure of the coach body. This manufacturing step will be explained by the example of the connection of a side wall module and roof module.

During the prefabrication of the profile subassemblies, individual parts of connection subassemblies 11 and 12 were tied up by means of laser welds, on those end faces lying flush with the outer edge of the outer edge of a window panel, to the profiles of a window panel which run in the vertical direction of the coach body. During the prefabrication of the profile subassemblies, the counterpieces of these individual parts were tied up by means of laser welds, on those end faces lying flush with the outer edge of the roof module, to those profiles of the module sections of the roof module 15 which run transversely with respect to the longitudinal axis of the coach body.

The individual parts are correspondingly arranged geometrically on the side wall module and roof module and are joined together by way of specially-designed screw connections. These screw connections complete the specially-designed connection subassembly 5 for the connection of the roof module and side wall module. The side wall module and undercarriage are similarly joined together by use of specially-designed connection subassemblies 6. After the cold joining of all the modules in the corresponding way, the complete coach body part is finished.

The present invention being thus described, it will be obvious that the same may be varied in many ways. Such variations are not to be regarded as a departure from the spirit and scope of the present invention, and all such modifications are intended to be included within the scope of the present invention.

1. A modularly constructed coach body, comprising:
an undercarriage module;
a roof module; and
side wall modules, the modules having dimensions corresponding to a length, width and height of the coach body, the undercarriage module, the roof module and the side wall modules each being subdivided in a longitudinal direction of the coach body into module sections formed in a differential type of construction from respective individually prefabricated subassemblies, both the individually prefabricated subassemblies and the module sections being joined together via cold-mountable connection elements to form the module sections, and module sections being joined together as the respective undercarriage module, side wall module and roof module.

2. The coach body as claimed in claim 1, wherein the module sections alone form a load-bearing skeleton of the coach body and receive claddings, arranged on an inside and on an outside, the claddings having no load-bearing function in static terms.

3. The coach body as claimed in claim 1, wherein the module sections include installation components and at least one of windows, public address, lighting, ventilation, air conditioning and indicator instruments.

4. The coach body as claimed in claim 1, wherein the module sections, before being joined together, include at least one of electrical, pneumatic, hydraulic and optical lines and include corresponding connection elements for coupling these lines when the module sections are being joined together into the corresponding larger modules.

5. The coach body as claimed in claim 1, wherein the module sections include dimensions which are no larger than the interior dimensions of current transport containers.

6. A method for producing a coach body as claimed in claim 1, comprising:
providing the individually prefabricated subassemblies, during their prefabrication, with bores cut by a laser beam, the subassemblies being joined together into the module sections solely as a result of the insertion of the cold-mountable connection elements into the bores.

7. A method for producing a coach body as claimed in claim 1, comprising:
attaching components of the cold-mountable connection elements by low-distortion laser welding to the individually prefabricated subassemblies during the prefabrication of the subassemblies, the components being brought into operative connection with and connected to corresponding components when the module sections are being joined together into the larger modules.

8-18. (canceled)

19. The modularly constructed coach body of claim 1, wherein the body is for rail vehicles for passenger transport.

20. The coach body as claimed in claim 2, wherein the module sections include installation components and at least one of windows, public address, lighting, ventilation, air conditioning and indicator instruments.

21. The coach body as claimed in claim 2, wherein the module sections, before being joined together, include at least one of electrical, pneumatic, hydraulic and optical lines and include corresponding connection elements for coupling these lines when the module sections are being joined together into the corresponding larger modules.

22. The coach body as claimed in claim 3, wherein the module sections, before being joined together, include at least one of electrical, pneumatic, hydraulic and optical lines and include corresponding connection elements for coupling these lines when the module sections are being joined together into the corresponding larger modules.

23. The coach body as claimed in claim 2, wherein the module sections include dimensions which are no larger than the interior dimensions of current transport containers.

24. The coach body as claimed in claim 3, wherein the module sections include dimensions which are no larger than the interior dimensions of current transport containers.

25. The coach body as claimed in claim 4, wherein the module sections include dimensions which are no larger than the interior dimensions of current transport containers.
